(19) United States
(12) Patent Application Publication
(10) Pub. No.: US 2013/0052622 A1
(43) Pub. Date: Feb. 28, 2013

(54) CHILD DEVELOPMENT SIT TO STAND DEVICE

(71) Applicant: Salvatore Calabrese, Philadelphia, PA (US)

(72) Inventor: Salvatore Calabrese, Philadelphia, PA (US)

(21) Appl. No.: 13/218,187

(22) Filed: Aug. 25, 2011

(51) Int. Cl. G09B 19/00

(52) U.S. Cl. 434/247

(57) ABSTRACT

A child development sit to stand device comprises a support. At least one fixture is connected to the support for permitting a child to grasp with his hand and raise his own body upwardly under his own ability. A reflective surface is attached to the support for attracting the child to and to use the standing device, facilitating the goal of developing the child's ability to stand. And, a method for assisting in the development of a child to perform a sit to stand movement. The method includes positioning the device into an initial position for the device to be commensurate with the child's ability and, as the child achieves the desired goal of standing, the device is positioned into a more advanced position, increasing the level of difficulty for the child to stand.

### STATEMENT REGARDING FEDERALLY SPONSORED RESEARCH OR DEVELOPMENT

The present invention was not developed with the use of any Federal Funds, but was developed independently by the inventor.

### CROSS-REFERENCE TO RELATED APPLICATIONS

None.

### BACKGROUND OF THE INVENTION

The typical normal infant has the cognitive and neuromuscular attributes to transition from a sitting position to stand position starting on average around eight months to ten months of life. This is collaborated by the findings of Wells et al. entitled Biomechanics of Growth and Development in the Healthy Human Infant published in the Journal of the American Osteopathic Association, June 2002, Vol. 102, No. 6., stating, “By 9 months, 88% of the observed infants could sit and 69% could pull themselves up to a stand.”

From a biomechanical viewpoint, the sit to stand movement has a typically narrowed base of support that is reached by the horizontal transfer of the center of mass above the area defined by the feet and the connecting line of their outer margins. Muscle force generated by simultaneous trunk and knee flexion initiates a reaction force which enables the forward movement of the thighs followed by the seat clearance. The horizontal movement of the body changes into vertical defined as a continual movement of center of mass forward and upward. This is the moment when the feet become the base of support and is considered a key point in the successful transfer of the body weight from the seat base of support. There is a four-phase division of the sit to stand movement. The first phase (trunk flexion) is initiated with the first recognizable movement and ends just before rising. In the second phase (momentum transfer) the body continues the forward movement and maximal dorsal flexion in the ankle joint is reached. This initiates the beginning of the third phase (hip joint extension) which is completed with maximal extension in the hip joint. The fourth phase (movement stabilization), in which the angular velocity equals zero, completes the entire movement.

The sit to stand movement is considered a critical child development milestone. Motor or movement skills, such as sit to stand reflects a child's ability to control and direct voluntary muscle movement. Motor control develops from the top down and from central to peripheral muscles. Thus an infant will first hold his head up and much later walk. The degree of motor development is seen in stages of lying prone, head lifting, rolling over, sitting, crawling, standing and walking. Motor skills are indentified as either gross or fine. Gross motor skills involve the use or movement of large muscles in the body such as the arms, legs, or entire body. Fine motor skills involve the use or movement of small muscles in the body to accomplish small tasks such as grasping an object or play item between the thumb and forefinger commonly referred to as a pincer grasp which also develops hand to eye coordination. The significance of the specific accomplished milestones as defined by motor or movement skills; serve as markers of normal development and indicators of readiness for new physical and sensory challenges according to the American Academy of Pediatrics.

Unfortunately, many infants who have either cognitive and/or neuromuscular deficiencies due to premature birth, congenital health problems or for unknown reasons encounter developmental delays and reach milestones such as the sit to stand movement later than typical normal infants, if ever. Delayed development of motor skills can be associated with certain diseases and abnormal conditions.

Caregivers usually consult with their pediatricians who may recommend physical and developmental therapies in an effort to catch the infant up with same-age peers. Often the use of supports, devices and aides will assist the infant in overcoming their unique set of mental and/or physical challenges which can include Down syndrome, cerebral palsy, muscular dystrophy, and the like. As with Down syndrome, joint hypermobility syndrome is the main underlying factor why these particular infants are unable to obtain the necessary milestones in a timely manner. These developmental challenges include muscle weakness, difficulty learning motor skills, under-arousal of new activities, difficulty with attention and engagement and finally a tendency to avoid tasks that are demanding.

Another consideration why infants do not achieve age-appropriate milestones is the lack of interest by the infant to perform certain tasks or movements as well as sensory stimulation presented by the individual activity. It was long been accepted that infants as early as six months of age are fascinated by their reflection in the mirror. In fact, they devote a great deal of time and effort exploring their bodies and their image as suggested by Jacques Lacan's Mirror Stage. Infants are born with the perceptual means to discriminate themselves from other objects and people. Early on, they express an implicit sense of themselves as embodied, differentiated, situated and effective in the physical and social environment. This is the basis of the mirror self-recognition tests which remains a valid instrument to assess self-knowledge at a conceptual and re-cognitory level.

Conventional sit to stand devices (hereinafter “STS devices”) that are commercially available have numerous design shortcomings, especially with respect to the infant's initial attempts to develop the sit to stand movement as with respect to providing a way to continually attract and engage the infant. For example, the Jonti-Craft Cruiser Center and Coordination Mirror are designed for infants that have already mastered the sit to stand movement and are in the process of learning to walk or cruise which encompasses taking small steps while holding onto a wall or furniture for balance. These devices anticipate the infant is already in a first standing position and is developing a second walking motion commensurate with the walking milestone. Additionally, these devices appear to be either permanent or semi-permanent with no ability to be easily moveable or transportable.

Other items that are commercially available are activity tables and walkers manufactured by companies such as Fisher-Price®, LeapFrog® and VTech® are unable to retain an infant's attention due to the product's limited and static set of activities. Additionally, because of the various shapes and configurations, these products force the infant to move in an unsecured and unbalanced position thereby placing the infant into a greater probability of slipping off the product and falling, in turn, potentially causing serious injury to the infants head and spine. Furthermore, infants with mental and/or physical challenges will tend to avoid interacting and engaging with these products thereby continuing milestone setbacks and failures.

Therefore, there exists the need for a developmental device which facilitates the development of a child's cognitive and neuromuscular abilities so that the child may more readily attain a standing position from a first position such as laying, crawling or sitting and to remain standing for a period of time.

It is an object of the present invention to provide a child development STS device to support, assist and aide in an infant's movement from a sitting position to a standing position by engaging the infant with sensory stimulation to attract the infant to the device and then ensuring the infant will utilize the device to achieve the desired objective of standing.

It is a further object of the present invention to provide a child development STS device that incorporates a progressive series of fixtures preferably in a vertically upward plane whereby an infant moves upwardly to a standing position from a first position such as laying, crawling or sitting.

It is another object of the present invention to provide a child development STS device that is secured directly to a vertical supporting surface, such as a wall or door.

It is yet another object of the present invention to provide a child development STS device that is transportable, moveable and freestanding in a vertically upward position and temporarily secured to a horizontal supporting surface through the use of ballast, such as metal, water, sand or the like so that the device will be essentially immovable against the weight, movement and force applied by an infant.

It is a still further object of the present invention to provide a child development STS device that is pivotable to freely move from a first substantially horizontal position to a second substantially vertical position with or without predetermined angulations therein.

Yet another object of the present invention to provide a child development STS device that utilizes the infant's reflection through interchangeable reflective surfaces that are either temporarily or permanently affixed to the device which attracts and engages the infant with the device.

And still yet another object of the present invention to provide a child development STS device that utilizes play items either temporary or permanent which attracts and engages the infant with the device.

And still a further object of the present invention to provide a child development STS device that contributes to the development of both gross and fine motor or movement skills

Additional objects, advantages and novel features of the present invention will become apparent to those skilled in the art from this disclosure, including the following detailed description, as well as by practice of the invention. While the invention is described below with reference to preferred embodiments, it should be understood that the invention is not limited thereto. Those of ordinary skill in the art having access to the teachings herein will recognize additional applications, modifications and embodiments in other fields, which are within the scope of the invention as disclosed and claimed herein and with respect to which the invention could be of significant utility.

### SUMMARY

In accordance with the present invention, a child development STS device which addresses the objects described above is shown and described.

A child development sit to stand device is disclosed. The STS device comprises a support. At least one fixture is connected to the support for permitting a child to grasp with his hand and raise his own body upwardly under his own ability. A reflective surface is attached to the support for attracting the child to and to use the STS device, facilitating the goal of developing the child's ability to stand.

In one form of the invention, the fixture has a tubular shape. In another form, the fixture is a peg which protrudes outwardly from the back support. In yet another form, the fixture comprises a plurality of spaced fixtures or pegs. In yet another form, the fixtures are removable or repositionable on the support.

The support may be a back support and the fixture is mounted to the back support. The back support may be substantially planar and the fixture may comprise radiused ends that engage the back support. The back support may also be cylindrical, rectangular or triangular in shape In another form, the support is freestanding and moveable.

In one form, the reflective surface covers substantially the entire surface of the support. The reflective surface may be interchangeable with other decorative surfaces.

One or more play items for attracting the child to use the STS device may be provided.

In one form, a mount is provided for mounting the STS device to a support surface. The mount permits the angulation of the device to be altered relative to the support surface.

A ballast for increasing the weight of the STS device may be provided.

In another form, the support comprises a back support and a side support further comprising a mount for mounting the STS device to a support surface. In yet another form, the support comprises a pair of side supports and the back support is a planar support, and wherein each side support is attached at opposite sides of the back support. The fixture is mounted to each side support.

A base, such as a foot plate or back brace, may be provided for supporting the STS device in an upright or angulated position. The STS device may be pivotably attached to the foot plate or back brace.

A method for assisting in the development of a child to perform a sit to stand movement is also disclosed. The method includes providing a child development sit to stand device comprising a support, at least one fixture connected to the support for permitting a child to grasp with his hand and raise his own body upwardly under his own ability, a reflective surface attached to the support for attracting the child to and to use the STS device, the device being pivotable between a plurality of positions. The STS device is positioned into an initial position for the device which is commensurate with the child's ability and, as the child achieves the desired goal of standing, the STS device is positioned into a more advanced position, increasing the level of difficulty for the child to stand.

The fixture may comprise a plurality of repositionable fixtures and further comprising the step of removing or repositioning at least one of the fixtures change the level of difficulty of the child using the STS device.

The step of removing or repositioning includes raising a lowermost fixture to a higher level. The method may also include the step of interchanging the reflective surface with other more engaging surfaces. The method may also include the step of positioning play items on the STS device to engage the child.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a front perspective view of a child development STS device according to a first preferred embodiment of the present invention;

FIG. 2 is a front perspective view of the child development STS device of FIG. 1 shown attached to a support surface in an inclined position;

FIG. 3 is a front perspective view of the child development STS device of FIG. 1 shown attached to a support surface in a vertical position;

FIG. 4 is a cross-sectional view of the child development STS device of FIG. 3 taken along line 4-4;

FIG. 5 is a cross-section view of the child development STS device of FIG. 3 taken along line 5-5;

FIG. 6 is cross-sectional view of an alternate embodiment of the child development STS device of FIG. 1;

FIG. 7 is an exploded front perspective view of a first alternate embodiment of a child development STS device of;

FIG. 8 is a partial front view of the child development STS device of FIG. 1;

FIG. 9 is a partial front view of an alternate embodiment of the child development STS device of FIG. 1;

FIG. 10 is a right side view of the child development STS device of FIG. 3;

FIG. 11 is a front perspective view of a second alternative embodiment of a child development STS device;

FIG. 12 is a third alternative embodiment of a child development STS device;

FIG. 13 is a fourth alternative embodiment of a child development STS device;

FIG. 14 is a partial cutaway view of the child development STS device of FIG. 13;

FIG. 15 is a top view of the child development STS device of FIG. 13;

FIG. 16 is a partial side view of the child development STS device of FIG. 11;

FIG. 17 is a partial side view of an alternate embodiment of the child development STS device of FIG. 11;

FIG. 18 is a fifth alternative embodiment of a child development STS device; and

FIG. 19 is a sixth alternative embodiment of a child development STS device.

### DETAILED DESCRIPTION OF THE INVENTION

References will now be made in detail to the preferred embodiments of the invention, examples of which are illustrated in the accompanying drawings. Wherever possible, the same reference numerals will be used throughout the drawings to refer to same or like parts.

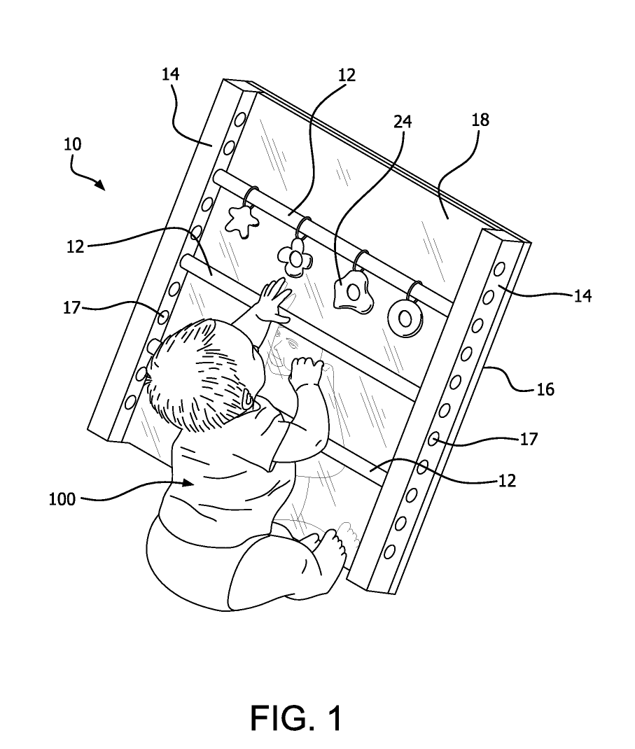

FIG. 1 shows is a shows child development sit to stand device (hereinafter “STS device”) 10 according to a first preferred embodiment of the present invention. The STS device 10 is designed to assist and aid in the development of a child's or infant's cognitive and neuromuscular abilities so that the child may more readily attain a standing position from a first position such as laying, crawling or sitting and to remain standing for a period of time. (The terms child and infant are used interchangeably in this application.)

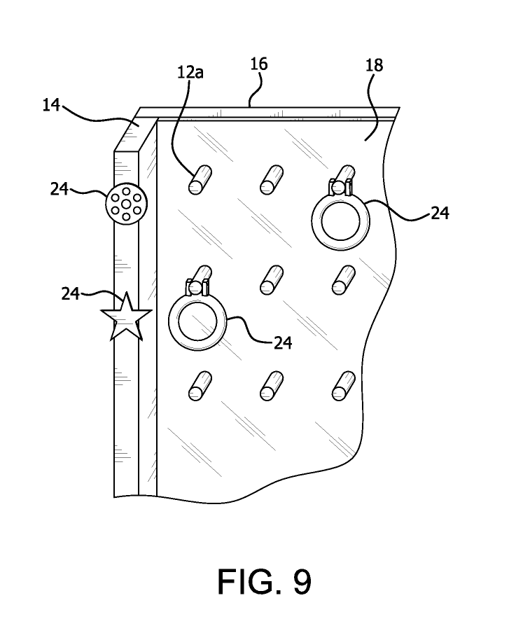

The STS device 10 comprises one or more fixtures 12 with each fixture 12 permitting a child to grasp with his hand and raise his own body upwardly under his own ability. A fixture is any suitable object that is fixedly secured in place and capable of supporting a user of the device when held. The fixture 12 should be of a general shape and size to accommodate a child's hand so that the fixture 12 facilitates being readily grasped and/or held by a child 100 and to develop hand to eye coordination. In the embodiment shown in FIG. 1, the fixture 12 is depicted as a tubular rod; however, it should be understood that other shapes also fall within the scope of the invention, such as square or rectangular cross-sectional shapes, oval cross-sectional shapes, and other contoured shapes that are readily grasped and/or held by a child 100. As shown in FIG. 9, the fixture can also take the form of a peg 12a, such as a round, square, rectangular, or contoured peg as well as a ring. Preferably, the fixture 12 is fabricated from incompressible injection or vacuum molded thermoplastic resin or a wooden based material.

The fixture 12 is secured to the side supports 14, on at least one edge is securely affixed either by mechanical or chemical fastening means, such as adhesives, rivets, stitching, welding, and the like. Preferably, the side support 14 is fabricated from the same material as the fixture 12, incompressible injection or vacuum molded thermoplastic resin or a wooden based material; however, it should be understood that the materials selected for the fixture 12, side supports 14, and other parts may be different. The terminal end of each fixture 12 should preferably not extend beyond the lateral outer edge of the side support 14 to avoid injury resulting in a child's impalement. In addition, fabricating a radius on each edge of each side support 14 preferably eliminates sharp right-angle corners wherever possible to avoid child injuries.

The fixture 12 is shown in FIG. 1 extending in a substantially horizontal position. It should be understood that the fixture 12 or 12a may be formed in almost any suitable orientation, such as substantially vertical, substantially inclined at various angles, and in combinations of the aforesaid orientations. In addition, in one preferred embodiment, the fixture 12 and 12a is removably secured to the side supports 14 by any suitable means, such as a ratchet and pawl fastener, a hook and loop fastener, and the like. In addition, in one form of the invention, the fixtures are intended to be repositionable at different positions and/or orientations. For example, the height of the fixtures 12 may be altered to change the difficulty of the STS device 10, such as removing the lowermost fixture and placing in higher up on the side support. Or, another reason to remove or reposition the fixture 12 or 12a is so that to eliminate the possibility of a more capable child attempting to climb up the STS device 10 using the fixtures as hand holds.

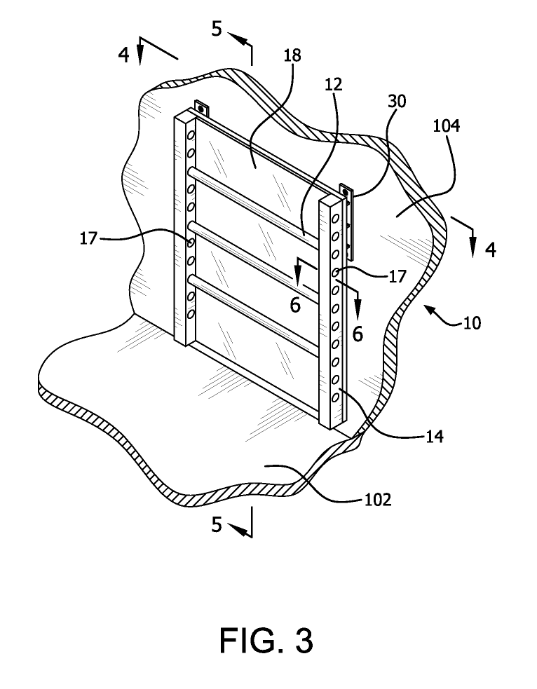

As shown in FIGS. 1-3, the STS device 10 can be supported in an upright or inclined position with the ends of the side supports contacting a horizontal supporting surface 102, such as a floor, the ground, water, or the like, and a vertical supporting surface, such as a wall, doors, door frames, or any other upright support surface 104. Both the horizontal 102 and vertical 104 supporting surface are capable of supporting the weight, and movement and force applied by of a child during use.

Each fixture 12 is shown oriented parallel to the horizontal supporting surface 102 and vertical supporting surface 104 and is oriented perpendicular to the side supports 14. As described above, it should be understood that the fixtures 12 may be positioned in many orientations besides the horizontal orientation shown. The fixture 12 and side support 14 are securely fastened either temporarily, moveable, and positionable with suitable fasteners or permanently as in the case of unitary construction during the fabrication process. In its permanently secured configuration, each fixture 12 along the length of the side support 14 has a predetermined interval or spacing between each fixture 12. For example, a STS device 10 having an overall height of forty-eight inches may have its lowermost fixture 12 securely affixed at six inch above the surface 102 and a predetermined interval spacing requirement of six inches will contain eight fixtures.

In its temporarily secured configuration, each fixture 12 may be repositionable or slidable along the medial edge of side support 14, such as by the spaced holes 17 shown or the like, whereby each fixture 12 can be infinitely or selectively positioned with variable intervals between each fixture. Alternatively, a fixture 12 may be oriented in a horizontal, vertical, angled or a combination thereof in relationship to a supporting surface to achieve the stated goal of the STS device 10 which is the ability to stand.

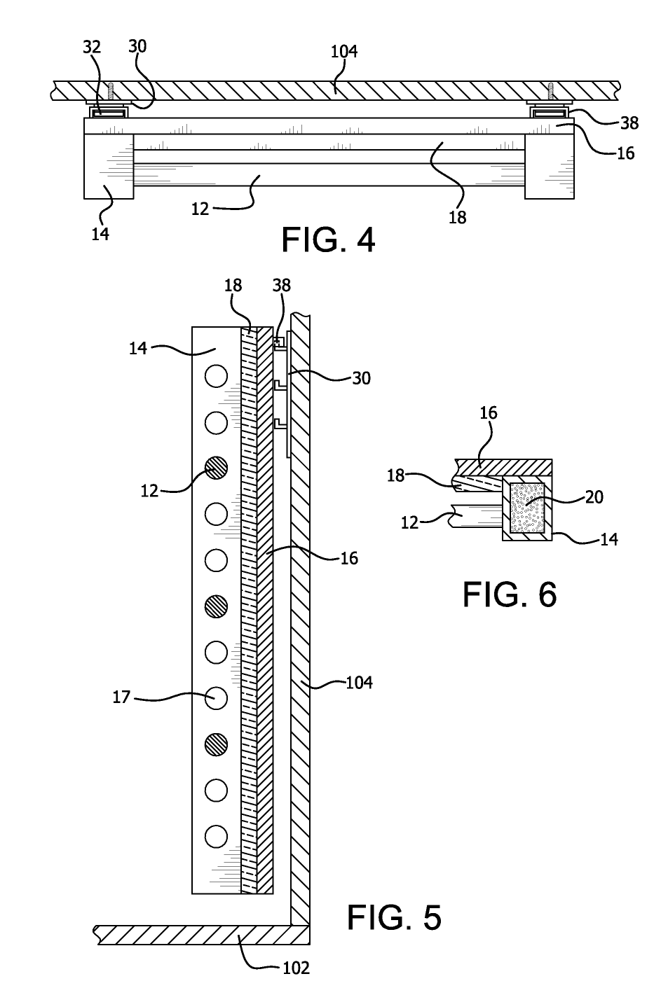

Referring now to FIGS. 1-6, the STS device 10 may also include a back support 16, preferably a planar surface, which connects to the side supports 14. Preferably, the back support 16 is fabricated from the same material as the fixture 12 and/or side support 14. All three elements: the fixture 12, side support 14, and back support 16 may be designed to be hollow or cored out during the manufacturing process and can accept ballast 20 (see FIG. 6), such as metal, sand, water or the like so the that the STS device 10 is essentially immovable against the weight, movement and force applied by a child.

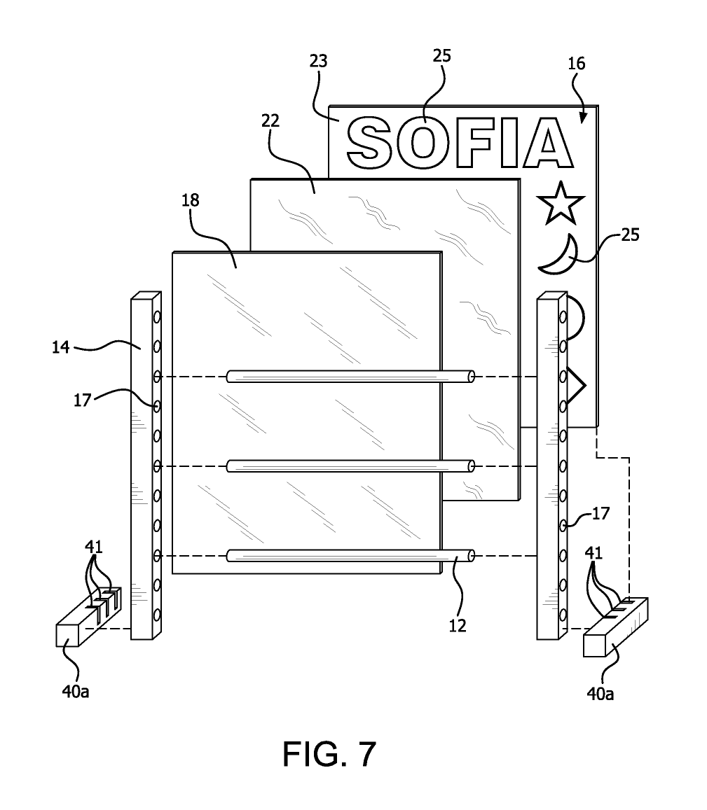

As best shown in FIG. 7, the STS device 10 may also include an interchangeable reflective surface 18, such as a safety glass mirror, a distorted mirror 22, etched mirror surface 23, reflective Mylar® film, or the like positioned behind the fixture 12 affixed to the back support 16 either permanently secured with mechanical or chemical fasteners or temporarily removable with hook and loop fasteners (not shown). The surfaces 16, 18, 22, and 23 are designed to be interchangeably repositioned and held in place in slots 41 formed in footplates 40a. The reflective surface 18 is designed such that a child 100 will be attracted to and use the STS device 10 to achieve the goal of developing the ability to stand. For example, as the child 100 becomes uninterested with a particular reflective surface 18 such as a safety glass mirror, it can be easily replaced with a more engaging reflective surface 18, such as a distorted mirror 22 which will stimulate the child 100 once again. To increase the attractiveness of the surfaces 16, 18, 22, 23 decorative indicia 25 may be provided. Once a child 100 is engaged with the reflective surface 18, he will become fascinated by his individual expressions and fluid movements which are uniquely his, always changing and a continual source of entertainment.

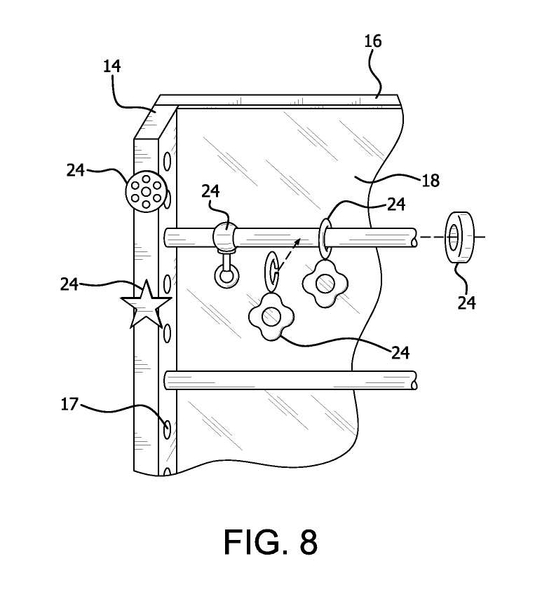

Referring back to FIGS. 1-6, the STS device 10 may also include play items 24, such as toys, stuffed animals or shapes which can be attached to the fixtures 12, side support 14 or reflective surface 18 (see FIGS. 8 and 9) either permanently secured with mechanical or chemical fasteners or temporarily removable with hook and loop fasteners (not shown) so that a child 100 will be attracted to and use the STS device 10 to achieve the goal of developing the ability to stand. Repositioning and/or introducing new play items 24 onto the STS device 10 will be a continual source of entertainment.

As best seen in FIGS. 1, 8, and 9, the play items 24 are arranged on the various fixtures 12, side supports 14 or reflective surface 18 to encourage the child 100 to reach to a first level, such as this middle fixture, whereby he is forced to transition his body in an vertically upward movement so that he can interact with the play items 24, which is a desirable source of accomplishment while developing the child's pincer grasp as well as hand to eye coordination. As the child 100 achieves a level, the play items 24 may be repositioned to a higher level, such as on the highest fixtures. This progression continues until the child 100 is able to reach a proscribed height and thereby achieve the position of standing.

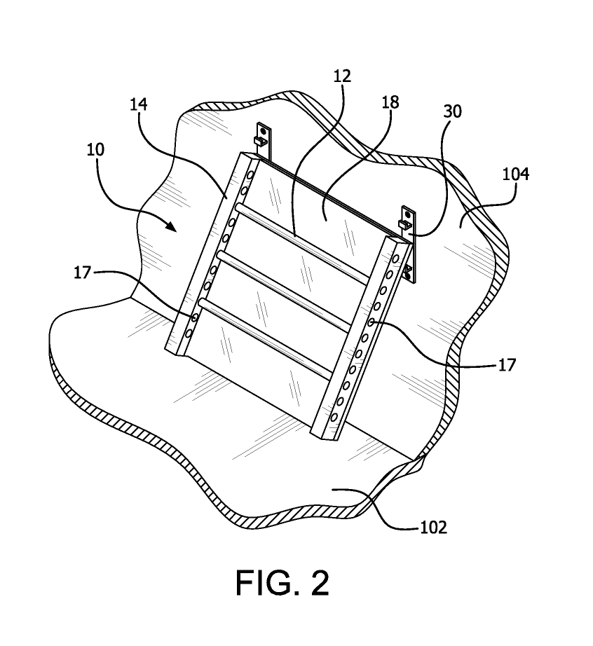

Referring now to FIGS. 2-5, the STS device 10 may be secured directly to a vertical support surface 104, such as a wall or door, permanently with mechanical or chemical fasteners (not shown). Alternatively, the STS device 10 can be temporarily secured to a wall or door 104 with the use of mounting brackets 30.

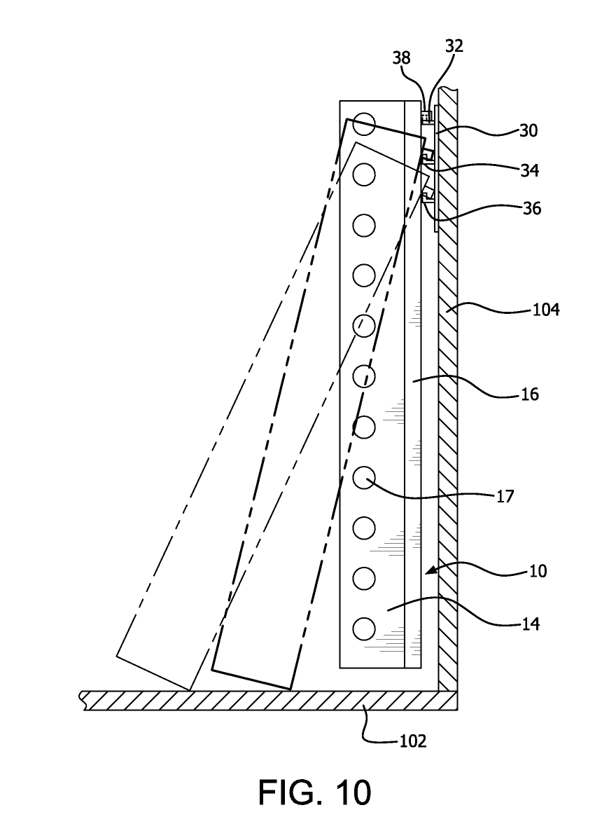

Referring now to FIGS. 2-5 and 10, the STS device 10 is pivotable to freely move from a first substantially parallel position relative to the vertical supporting surface 104 to a second substantially perpendicular position relative to the vertical supporting surface 104, with or without intermediate angulations, which is best shown in FIGS. 2 and 10. The angularity is generated at essentially the topmost portion of the STS device 10. The ability to configure the STS device 10 at various inclinations or at a more perpendicular position relative to the vertical supporting surface 104 allows the child 100 to engage at a decreased level of difficulty because the child's center of mass is at least partially over the STS device 10 as opposed to alongside of it when the STS device 10 is in its parallel (or substantially vertical) position.

As best seen in FIG. 10, the child's ease of use occurs at a predetermined angle so that he can acquire his initial source of accomplishment. From here, the STS device 10 is position to a less perpendicular angle. This progression continues until the child 100 is able to reach a proscribed height when the STS device 10 is parallel to the vertical supporting surface 104 and thereby achieve the position of standing. The mounting brackets 30 have a series of hook elements 32, 34, 36 that are matingly engagable and temporarily secured with a load bearing hooks 38 located on the upper back portion of the back support 16.

Preferably, the STS device 10 contains ballast 20 (see FIG. 6), such as metal, water, sand or the like and when securely positioned onto the mounting brackets 30 will be essentially immovable against the weight, movement and force applied by a child.

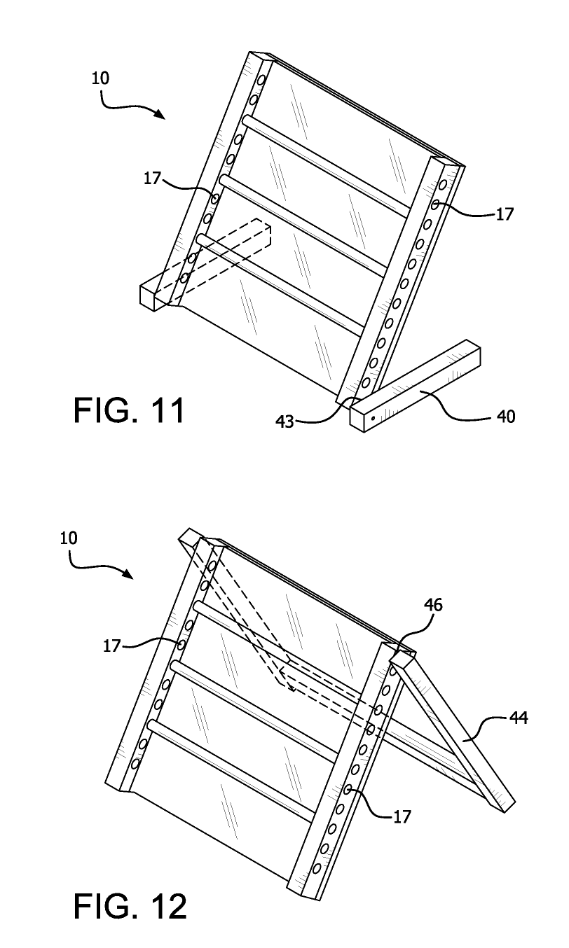

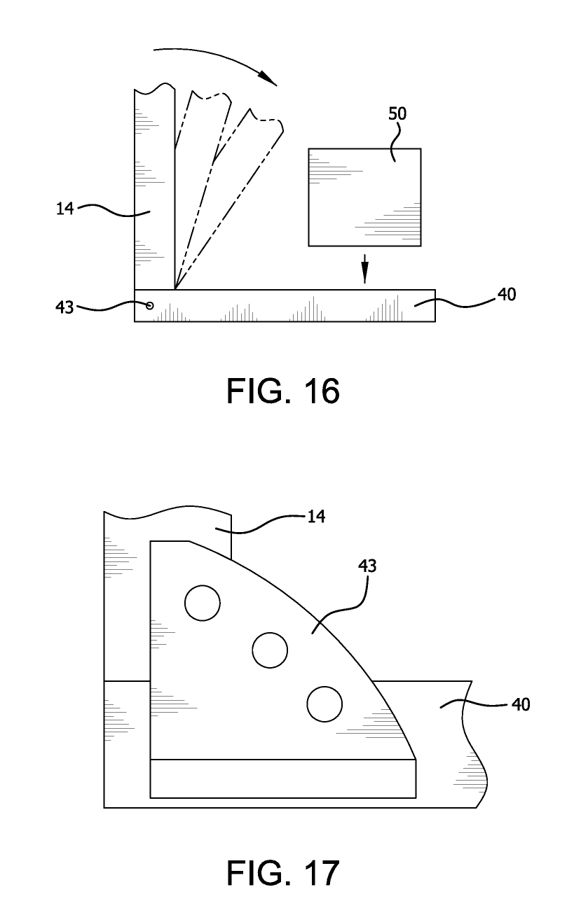

As shown in FIGS. 7, 11, and 12, the STS device 10 contains a base, such as footplate 40 or 40a which is connected to the side support 14. The footplate 40 is connected to the side support 14 through a lower moveable hinge 43 (see FIGS. 16 and 17) with selectable angulations on the lowermost portion of the STS device 10. Preferably, the forward portion of the footplate 40 does not exceed the side support 14 thereby eliminating a potential trip hazard and injury. Conversely, as shown in FIG. 12, the STS device 10 contains a base, such as back brace 44 which is connected to the side support 14 through an upper moveable hinge 46 with selectable angulations on the uppermost portion of the device.

These designs allow the STS device 10 to be transportable, movable and freestanding which permits a child to develop his sit to stand movement in virtually any indoor or outdoor environment, thereby further changing their source of entertainment while continuing to engage the child. These devices are pivotable to freely move from a first substantially parallel position relative to horizontal supporting surface 102 to a second substantially perpendicular position relative to the horizontal supporting surface 102, with or without, predetermined angulations which is accomplished by either an upper moveable hinge 46 or a lower moveable hinge 43. The ability to configure the STS device 10 at an angle less than perpendicular position relative to horizontal supporting surface 102 allows the child to engage at a decreased level of difficulty because the child's center of mass is at least partially over the STS device 10 as opposed to alongside of when the STS device 10 is in its substantially perpendicular position. From here to STS device 10 may be positioned to a more perpendicular angle. This progression continues until the child is able to reach a proscribed height when the STS device 10 is perpendicular to the horizontal supporting surface 102 and thereby achieve the position of standing.

Preferably, both the footplate 40 and the back brace 44 are fabricated from incompressible injection or vacuum molded thermoplastic resin or a wooden based material are designed to be hollow or cored out during the manufacturing process and can accept ballast 20 (see FIG. 6), such as metal, sand, water or the like so that the STS device 10 is essentially immovable against the weight, movement and force applied by a child.

Now referring to FIG. 16, the STS device 10 may also include a removable external container 50 to provide ballast 20,such as metal, sand, water or the like to compliment the device's internal ballast 20 or as a standalone weight which is positioned onto the footplate 40 or the back brace 44 (FIG. 12); however, it should be understood that the material selected for the, external container 50 and the STS device 10 individual components may be different. An advantage using at least one or more external containers 50 is to evenly distribute the containers' weight across the required individual components such as the footplates 40 to temporarily secure the STS device 10 to the supporting surface 102. Another advantage using an external container 50 is to reduce the weight of the STS device 10 to ensure ease of transportation and assembly. And, yet another advantage is to sufficiently increase the STS device's 10 overall weight so that it becomes substantially immovable against the weight, movement and force applied by a child 100.

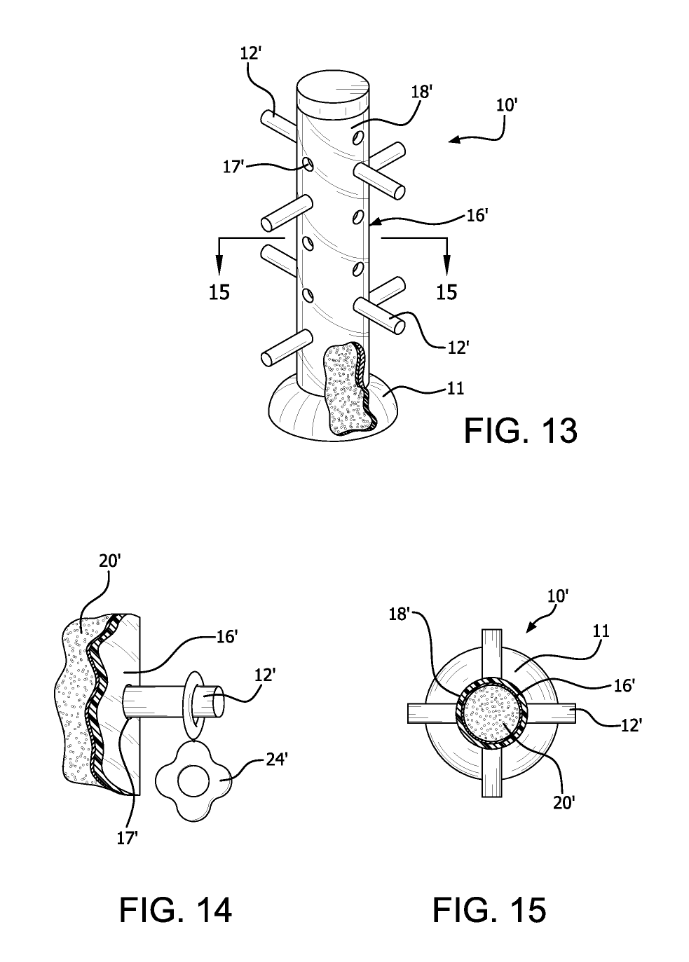

In another embodiment and referring to FIGS. 13-15, the STS device 10′ may have a form other than the rectangular version seen in FIG. 1, such as triangular or cylindrical shape, due to space constraints, personal preferences and child interactions. As shown in FIG. 13, the STS device 10′ incorporates a stationary base 11 which is fabricated from incompressible injection or vacuum molded thermoplastic resin and may also be hollow to accommodate ballast 20′,such as metal, sand, water or the like will temporarily secured to the horizontal supporting surface 102. A cylindrical upright 16′ is fabricated from the same material as the stationary base 11 such as incompressible injection or vacuum molded thermoplastic resin. It should be understood, however, that the materials selected for the stationary base 11, cylindrical upright 16′, and other parts may be different. The cylindrical upright 16′ may also be hollow to accommodate ballast 20′ such as metal, sand, water or the like so that the device becomes essentially immovable against the weight, movement and force applied by a child. The stationary base 11 and cylindrical upright 16′ may be either integrally connected so that the individual components can be disassembled for ease of storage and transportation or permanently connected during the manufacturing process to form a unitary and monolithic structure.

Referring to the integral connection, the stationary base 11 and cylindrical upright 16′ are independent of each other and thus permitted to rotate around each other. Preferably, these individual components are connected in a preselected fixed relationship and are temporarily secured through a mechanical or chemical fastener, such as a lock or pin to eliminate injury to a child who may potentially become unstable and possibly fall off the STS device 10′.

The cylindrical upright 16′ may be wrapped or coated in an interchangeably reflective surface 18′, such as Mylar® film, or the like either permanently secured with mechanical or chemical fasteners or temporarily removable with hook and loop fasteners. Alternatively, the reflective surface 18′ may be disposed on the inner wall of the cylindrical upright 16′ as shown. The reflective surface 18′ is designed such that a child will be attracted to and use the STS device 10′ to achieve the goal of developing the ability to stand. For example as the child becomes uninterested with a particular reflective surface 18′, it can be easily replaced with a more engaging reflective surface 18′ which will stimulate the child once again.

Once a child is engaged with the reflective surface 18′, he will become fascinated by his individual expressions and fluid movements which are uniquely his, always changing and a continual source of entertainment.

The STS device 10′ contains a series of spaced permanently secured pegs 12′ permitting a child the ability to perform the sit to stand movement either in a clockwise/counterclockwise manner or selecting pegs randomly. Additionally, as best seen in FIG. 14, the cylindrical upright 16′ may contain a series of preselectedly spaced holes 17′ which will permit the pegs 12′ to be temporarily secured to the holes 17′ and is removable depending upon the requirements of the child's development. The pegs 12′ permit a child to grasp with his hand and raise his own body upwardly under his own ability. The pegs 12′ should be of a general shape and size to accommodate a child's hand so that the pegs 12′ facilitates being readily grasped and/or held by a child and to develop hand to eye coordination.

The play items 24′ (see FIG. 14) may be attached individual pegs 12′ or reflective surface 18′ either permanently secured with mechanical or chemical fasteners or temporarily removable with hook and loop fasteners so that a child will be attracted to and use the STS device 10′ to achieve the goal of developing the ability to stand.

The play items 24′ are arranged on the various pegs 12′, or cylindrical upright 16′ to encourage the child to reach to a first level whereby he is forced to transition his body in an vertically upward movement so that he can interact with the play items 24′ which is a desirable source of accomplishment while developing the child's pincer grasp as well as hand to eye coordination. As the child achieves a level, the play items 24′ are repositioned to the second level. This progression continues until the child is able to reach a proscribed height and thereby achieving the position of standing.

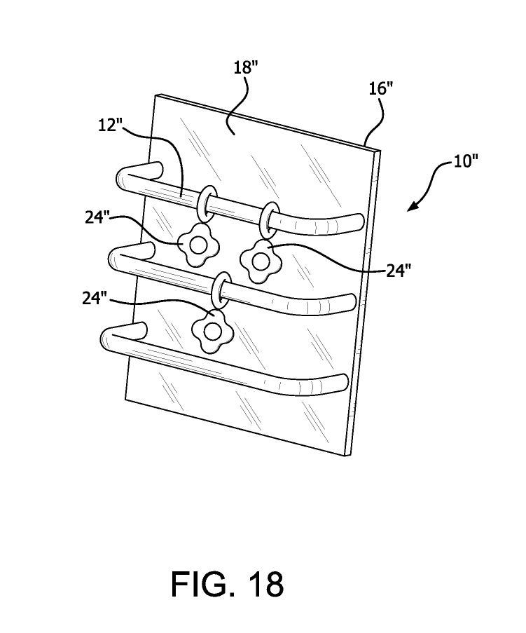

Referring now to FIG. 18, in yet another embodiment, the STS device 10″, comprises one or more fixtures 12″ with each fixture 12″ permitting a child to grasp with his hand and raise his own body upwardly under his own ability. The fixture 12″ should be of a general shape and size to accommodate a child's hand so that the fixture 12″ facilitates being readily grasped and/or held by a child and to develop hand to eye coordination. In the embodiment shown in FIG. 18, the fixture 12″ is depicted as a tubular rod; however it should be understood that other shapes also fall within the scope of the invention, such as square or rectangular cross-sectional shapes, oval cross-sectional shapes, and other contoured shapes that are readily grasped and/or held by a child. As shown in FIG. 6, the fixture 12″ can take the form of a peg 12a (FIG. 9), such as a round, square, rectangular, or contoured peg as well as a ring. Preferably, the fixture 12″ is fabricated from incompressible injection or vacuum molded thermoplastic resin or a wooden based material.

The fixture 12″ is secured to back support 16″, by at least one connection and is securely affixed by suitable fastening means, such as adhesives, rivets, stitching, welding, and the like. Preferably, the back support 16″ is fabricated from the same material as the fixture 12″, incompressible injection or vacuum molded thermoplastic resin or a wooden based material. It should be understood, however, that the materials selected for the fixture 12″, back support 16″, and other parts may be different. The back support 16″ may be secured either permanently or temporarily to any form of structure in an essentially horizontal plane or essentially vertical plane relative to the supporting surface.

The connection between the fixture 12″ and back support 16″ can be at any location along the length of the fixture 12″ such as the medial area or distal ends. Preferably, each free end of the fixture 12″ will have a radius edge and terminate into the back support 16″. Additionally, fixture 12″ will not extend beyond the back support 16″ to avoid injury resulting in a child's impalement. In addition, fabricating a radius on each edge of each side support 14″ preferably eliminates sharp right-angle corners wherever possible to avoid child injuries. Furthermore, the connection may either be permanently secure configuration with each fixture 12″ having predetermined interval spacing requirement or temporarily secured configuration with each fixture 12″ slidable along the medial edge of back support 16″ whereby each fixture 12″ can be infinitely or selectively changed with variable intervals between each fixture.

The STS device 10″ may also include an interchangeable reflective surface 18″, such as a safety glass mirror, a distorted mirror 22, etched mirror 23, reflective Mylar® film, or the like positioned behind the fixture 12″ affixed to the back support 16″ either permanently secured with mechanical or chemical fasteners or temporarily removable with hook and loop fasteners. The reflective surface 18″ is designed such that a child will be attracted to and use the STS device 10″ to achieve the goal of developing the ability to stand. As the child becomes uninterested with a particular reflective surface 18″, such as a safety glass mirror, it can be easily replaced with a more engaging reflective surface 18″, such as a distorted mirror 22 which will stimulate the child once again.

Once a child is engaged with the reflective surface 18″, he will be fascinated by his individual expressions and fluid movements which are uniquely his, always changing and a continual source of entertainment.

Additionally, the STS device 10″ may also include play items 24″, such as toys, stuffed animals or shapes which be attached to the fixtures 12″, back support 16″ or reflective surface 18″ either permanently secured with mechanical or chemical fasteners or temporarily removable with hook and loop fasteners so that a child will be attracted to and use the STS device 10″ to achieve the goal of developing the ability to stand. The play items 24″ are arranged on the various fixtures 12″, back support 16″ or reflective surface 18″ to encourage the child to reach to a first level whereby he is forced to transition his body in a vertically upward movement so that he can interact with the play items 24″ which is a desirable source of accomplishment while developing the child's pincer grasp as well as hand to eye coordination. As the child achieves a level, the play items 24″ are repositioned to the second level. This progression continues until the child is able to reach a proscribed height and thereby achieving the position of standing.

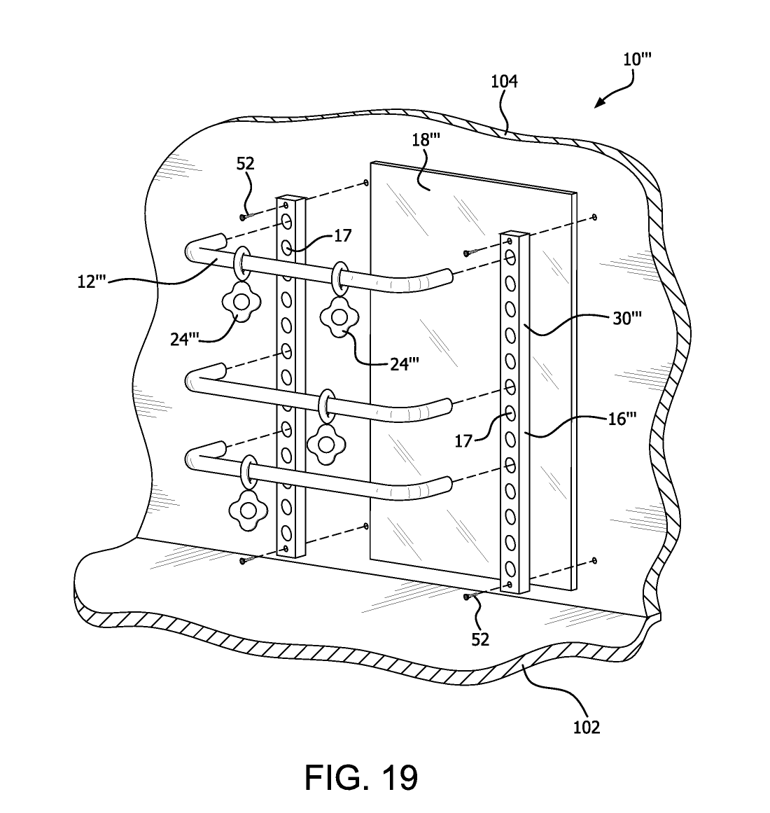

In still another embodiment and referring to FIG. 19, the STS device 10″′, comprises one or more fixtures 12′″ the each fixture 12′″ permitting a child to grasp with his hand and raise his own body upwardly under his own ability. The fixture 12′″ should be of a general shape and size to accommodate a child's hand so that the fixture 12′″ facilitates being readily grasped and/or held by a child 100 and to develop hand to eye coordination. In the embodiment shown in FIG. 19, the fixture 12′″ is depicted as a tubular rod; however it should be understood that other shapes also fall within the scope of the invention, such as square or rectangular cross-sectional shapes, oval cross-sectional shapes, and other contoured shapes that are readily grasped and/or held by a child 100. The fixture 12′″ can take the form of a peg 12a (FIG. 9), such as a round, square, rectangular, or contoured peg as well as a ring. Preferably, the fixture 12′″ is fabricated from incompressible injection or vacuum molded thermoplastic resin or a wooden based material.

The fixture 12′″ is secured to any immovable surface either directly by mechanical or chemical fastening means, such as adhesives, rivets, stitching, welding, and the like or indirectly with one or more mounting brackets 30′″. The mounting brackets 30′″ are secured to the surface 104 via suitable fasteners 52. Preferably, the mounting bracket 30′″ is fabricated from the same material as the fixture 12′″, incompressible injection or vacuum molded thermoplastic resin or a wooden based material, however, it should be understood that the materials selected for the fixture 12′′, mounting bracket 30′″, and other parts may be different. The immovable surface may be any form of structure in a substantially horizontal plane or substantially vertical plane relative to the supporting surface.

The connection between the fixture 12′″ and mounting bracket 30′″ can be at any location along the length of the fixture 12′″ such as the medial area or distal ends. Preferably, each free end of the fixture 12′″ will have a radius edge and terminate into the mounting bracket 30′″. Additionally, fixture 12′″ will not extend beyond the mounting bracket 30′″ to avoid injury resulting in a child's impalement. In addition, fabricating a radius on each edge of each side support 14′″ preferably eliminates sharp right-angle corners wherever possible to avoid child injuries. Furthermore, the connection may either be permanently secure configuration with each fixture 12′″ having predetermined interval spacing requirement or temporarily secured configuration with each fixture 12′″ slidable or repositionable along the mounting bracket 30′″, such as by the spaced holes 17′″ shown or the like, whereby each fixture 12′″ can be infinitely or selectively changed with variable intervals between each fixture.

The STS device 10′″ may also include an interchangeable reflective surface 18′″, such as a safety glass mirror, a distorted mirror, etched mirror, reflective Mylar® film, or the like positioned behind the fixture 12′″ affixed to the immovable surface 104 either permanently secured with mechanical or chemical fasteners or temporarily removable with hook and loop fasteners. In the embodiment shown, the mounting brackets 30′″ are secured to the reflective surface 18′″ and the immovable surface 104 via the fasteners 52. The reflective surface 18′″ is designed such that a child will be attracted to and use the STS device 10′″ to achieve the goal of developing his ability to stand. As the child becomes uninterested with a particular reflective surface 18′″, such as a safety glass mirror, it can be easily replaced with a more engaging reflective surface 18′″, such as a distorted mirror which will stimulate the child once again.

Once a child is engaged with the reflective surface 18′″, he will be fascinated by his individual expressions and fluid movements which are uniquely his, always changing and a continual source of entertainment.

Additionally, the STS device 10′″ may also include play items 24′″, such as toys, stuffed animals or shapes which be attached to the fixtures 12′″, reflective surface 18″′ or the immovable surface either permanently secured with mechanical or chemical fasteners or temporarily removable with hook and loop fasteners so that a child will be attracted to and use the STS device 10′″ to achieve the goal of developing the ability to stand. The play items 24′″ are arranged on the various fixtures 12″, reflective surface 18′″ or the immovable surface to encourage the child to reach to a first level whereby he must transition his body in a vertically upward movement so that he can interact with the play items 24′″ which is a desirable source of accomplishment while developing the child's pincer grasp as well as hand to eye coordination. As the child achieves a level, the play items 24′″ are repositioned to the second level. This progression continues until the child is able to reach a proscribed height and thereby achieve the position of standing.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A child development sit to stand device, comprising:
a support;
at least one fixture connected to the support for permitting a child to grasp with his hand and raise his own body upwardly under his own ability;
a reflective surface attached to the support for attracting the child to and to use the standing device, whereby facilitating the goal of developing the child's ability to stand.

2. The child development sit to stand device according to claim 1 wherein the at least one fixture has a tubular shape.

3. The child development sit to stand device according to claim 1 wherein the at least one fixture is a peg which protrudes outwardly from the support.

4. The child development sit to stand device according to claim 1 wherein the at least one fixture comprises a plurality of spaced fixtures.

5. The child development sit to stand device according to claim 4 wherein at least one of the fixtures is removable or repositionable on the support.

6. The child development sit to stand device according to claim 1 wherein the support is a back support and the at least one fixture is mounted to the back support.

7. The child development sit to stand device according to claim 6 wherein the back support is substantially planar and the at least one fixture comprises radiused ends that engage the back support.

8. The child development sit to stand device according to claim 6 wherein the back support is freestanding and moveable.

9. The child development sit to stand device according to claim 6 wherein the back support has a cylindrical, rectangular or triangular shape.

10. The child development sit to stand device according to claim 1 wherein the reflective surface covers substantially the entire surface of the support.

11. The child development sit to stand device according to claim 1 wherein the reflective surface is interchangeable with other decorative surfaces.

12. The child development sit to stand device according to claim 1 further comprising one or more play items for attracting the child to use the standing device.

13. The child development sit to stand device according to claim 1 further comprising a mount for mounting the device to a support surface.

14. The child development sit to stand device according to claim 13 wherein the mount permits the angulation of the device to be altered relative to the support surface.

15. The child development sit to stand device according to claim 1 further comprising a ballast for increasing the weight of the device.

16. The child development sit to stand device according to claim 1 wherein the support comprises a back support and a side support further comprising a mount for mounting the device to a support surface.

17. The child development sit to stand device according to claim 1 wherein the support comprises a pair of side supports and the back support is a planar support, and wherein each side support is attached at opposite sides of the back support.

18. The child development sit to stand device according to claim 17 wherein the at least one fixture is mounted to each side support.

19. The child development sit to stand device according to claim 17 further comprising a base for supporting the device in an upright or angulated position.

20. The child development sit to stand device according to claim 19 wherein the device is pivotably attached to the base.

21. The child development sit to stand device according to claim 19 wherein the base is a foot plate or back brace.

22. The child development sit to stand device according to claim 17 wherein the at least one fixture comprises a plurality of spaced fixtures.

23. The child development sit to stand device according to claim 22 wherein at least one of the fixtures is removable or repositionable on the support

24. A method for assisting in the development of a child to perform a sit to stand movement, comprising the steps of:
providing a child development sit to stand device comprising a support, at least one fixture connected to the support for permitting a child to grasp with his hand and raise his own body up under his own ability, a reflective surface attached to the support for attracting the child to and to use the standing device, the device being pivotable between a plurality of positions;
positioning the device into an initial position for the device to be commensurate with the child's ability; and
as the child achieves the desired goal of standing, positioning the device into a more advanced position increasing the level of difficulty for the child to stand.

25. The method for assisting in the development of a child to perform a sit to stand movement according to claim 24, wherein the at least one fixture comprises a plurality of repositionable fixtures and further comprising the step of removing or repositioning at least one of the fixtures change the level of difficulty of the child using the device.

26. The method for assisting in the development of a child to perform a sit to stand movement according to claim 25, wherein the step of removing or repositioning includes raising a bottom-most fixture to a higher level.

27. The method for assisting in the development of a child to perform a sit to stand movement according to claim 24, comprising the step of interchanging the reflective surface with other more engaging surfaces.

28. The method for assisting in the development of a child to perform a sit to stand movement according to claim 24, comprising the step of positioning play items on the device to engage the child
